(19) United States
(12) Patent Application Publication
(10) Pub. No.: US 2013/0227066 A1
(43) Pub. Date: Aug. 29, 2013

(54) DATA TRANSFER APPARATUS AND DATA TRANSFER METHOD

(71) Applicant: Tadashi Sato, Tokyo (JP)

(72) Inventor: Tadashi Sato, Tokyo (JP)

(73) Assignee: NEC CORPORATION, Minatu-ku, Tokyo (JP)

(21) Appl. No.: 13/824,868

(22) PCT Filed: Mar. 23, 2012
(86) PCT No.: PCT/JP2012/057564

§ 371 Date: Mar. 18, 2013

(30) Foreign Application Priority Data
Mar. 25, 2011 (JP) 2011-068486

(51) Int. Cl. H04L 29/08

(52) U.S. Cl. CPC H04L 67/02
USPC 709/217

(57) ABSTRACT

An object of the present invention is to prevent the occurrence of deadlocks regardless of the size of a message communication buffer. When data sent to a first address is received, a data transfer apparatus determines another data transfer apparatus as a data transfer destination, based on a routing table. When a magnitude relationship between the identifier of the own apparatus and the identifier of the another data transfer apparatus is in one condition, the data is transmitted to the first address of the another data transfer apparatus. When the magnitude relationship is in the other condition, the data is transmitted to the second address of the another data transfer apparatus. When the data sent to the second address of the own apparatus is received, the another data transfer apparatus is determined as the data transfer destination based on the routing table, and the data is transmitted to the second address of the another data transfer apparatus.

### BACKGROUND

The present invention relates to a data transfer apparatus and a data transfer method.

A structured P2P (Peer to Peer) network has been attracting attention as a network for realizing high-speed data transfer between nodes. In a data distribution system using the structured P2P network, a plurality of data transfer apparatuses cooperate with each other to realize high-speed distribution of large quantities of data. Data to be distributed are input from a data transmitter to any of the data transfer apparatuses configuring the data distribution system and are distributed from the data transfer apparatus or another data transfer apparatus to a data receiver.

In such data distribution system, each of the data transfer apparatuses can communicate with the other data transfer apparatuses via a network connected by a transmission medium such as a LAN (Local Area Network) cable. A plurality of data transmitters can transmit data to any of the data transfer apparatuses via the network. In the data distribution system, the data transfer apparatuses cooperate with each other to distribute the data, which are received from the data transmitters, to a data receiver that is in charge of processing the data. Therefore, each data transfer apparatus previously stores therein the addresses of some of the other data transfer apparatuses, and determines an address to transfer the data to, from among the group of stored addresses, in accordance with a predetermined procedure, so that the data eventually reach the data receiver that is in charge of processing the data.

In the system disclosed in Non-Patent Document 1, the ID of each node (data transfer apparatus) is configured by a value (key) of m-bit length. Each data transfer apparatus transfers data, which is received from a data transmitter or another data transfer apparatus, to a successor corresponding to a hash value (key) of the data. A successor corresponding to a key k is one of the data transfer apparatuses configuring the data distribution system, the ID of which indicates the key closest to the key k.

According to Non-Patent Document 1, key (m bits) is expressed by a factor ring modulo 2^{m}, and a key that is distant from any key k by d is expressed as (k+d)mod 2^{m}, as shown in FIG. 26. In the example shown in FIG. 26, when m=3, the key that is distant from a key 7 by 2 is expressed as (7+2)mod 2³=1.

In the system disclosed in Non-Patent Document 1, each data transfer apparatus holds the addresses of some of the other data transfer apparatuses in order to transfer the data to these data transfer apparatuses. These addresses correspond to the addresses of the successors having keys s (base point keys) that are distant from the ID of the data transfer apparatus by 2ⁱ⁻¹ (i=1, 2, . . . , m). According to the example shown in FIG. 26, in the data transfer apparatus with ID number 0, the base point key is 0+2¹⁻¹=1 (mod 2³) when i=1. The successor thereof is a data transfer apparatus with ID number 1. Further, the base point key is 0+2²⁻¹=2 (mod 2³) when i=2. The successor of this data transfer apparatus is a data transfer apparatus with ID number 3.

FIG. 27 shows an example of internal configurations of three data transfer apparatuses shown in FIG. 26 and a flow of data therein. The data transfer apparatuses 0, 1, 3 are provided with ID numbers 0, 1, 3, respectively. Each of the data transfer apparatuses has a receiving queue for temporarily holding data received from the other transfer apparatuses, a transfer unit for extracting the data from the receiving queue and determining a transfer-destination apparatus to transfer the data to, and a transmission queue for temporarily holding the data to be transmitted to the other apparatuses. The arrows shown in FIG. 27 represent the flow of data. For example, in FIG. 27, the arrow from a transmission queue s0-3 of the data transfer apparatus 0 to a receiving queue r1-1 of the data transfer apparatus 1 represents how data flows from the data transfer apparatus 0 to the data transfer apparatus 1.

According to the configurations shown in FIG. 27, when the transmission queue or receiving queue of each data transmission apparatus is filled with data, back pressure is applied in order to temporarily stop the process to be performed by the preceding unit, preventing the data from overflowing from the queue. The unit preceding the transmission queue in each data transfer apparatus is the transfer unit, and the unit preceding the receiving queue is a data transmitter or the transmission queue of the other data transfer apparatus. Moreover, the transfer unit applied with the back pressure from the transmission queue cannot insert the data into the transmission queue even after determining the data transfer destination. Therefore, the data cannot be extracted from the receiving queue until the transmission queue has a space.

Non-Patent Document 1: Ion Stoica, and three others, “Chord: A Scalable Peer-to-peer Look up Service for Internet Applications,” ACM SIGCOMM Computer Communication Review 31(4), U.S.A., ACM Press, 2001, p. 149-160

Patent Document 1: Patent Publication JP-A-2007-328813

Incidentally, in the configurations shown in FIG. 27, a deadlock is likely to occur in a section where the data flows in the form of a ring. For instance, a ring of data is configured by six data flows: a data flow from the transfer unit of the data transfer apparatus 0 to the transmission queue s0-3, a data flow from the transmission queue s0-3 to the receiving queue r1-1, a data flow from the receiving queue r1-1 to the transfer unit of the data transfer apparatus 1, a data flow from the transfer unit of the data transfer apparatus 1 to a transmission queue s1-1, a data flow from the transmission queue s1-1 to a receiving queue r0-3, and a data flow from the receiving queue r0-3 to the transfer unit of the data transfer apparatus 0.

An example of a deadlock is now described. Suppose that large quantities of data are input from the data transmitter to the data transfer apparatus 0. For example, the transfer unit of the data transfer apparatus 0 determines to transfer the data received from the data transmitter, to the data transfer apparatus 1, and inserts the data into the transmission queue s0-3. In so doing, suppose that the process for extracting the data from the transmission queue s0-3 in order to allow the data transfer apparatus 0 to transmit the data to the data transfer apparatus 1 is performed later than the process for inserting the data from the transfer unit of the data transfer apparatus 0 into the transmission queue s0-3, and that the transmission queue s0-3 is filled with data. In such a case, a back pressure is applied from the transmission queue to the transfer unit, preventing the transfer unit from extracting the data from the receiving queue. Consequently, the receiving queue r0-3 becomes too full to hold the data received from the data transfer apparatus 1, and a back pressure is applied from the data transfer apparatus 0 to the data transfer apparatus 1.

On the other hand, suppose that large quantities of data are input from a data transmitter to the data transfer apparatus 1. For instance, the transfer unit of the data transfer apparatus 1 determines to transfer the data received from the data transmitter, to the data transfer apparatus 0, and inserts the data into the transmission queue s1-1. In this case, as with the case of the data transfer apparatus 0, the receiving queue r1-1 becomes filled with data, and consequently a back pressure is applied from the data transfer apparatus 1 to the data transfer apparatus 0. In such circumstances, the data transfer apparatus 0 and the data transfer apparatus 1 apply a back pressure to each other and remain unable to transmit data. In other words, a deadlock state occurs.

Patent Document 1 discloses an example of a method for avoiding the occurrence of deadlocks. In the method disclosed in Patent Document 1, a message communication buffer, large enough for a node corresponding to a data transfer apparatus to constantly process input messages, is secured for the purpose of avoiding a deadlock. This method relates to increasing the sizes of the transmission queues and receiving queues shown in FIG. 27. In other words, increasing the sizes of the transmission queues and receiving queues to prevent the queues from being filled with data can eliminate the need to apply back pressure to the preceding processing units or processors, preventing the occurrence of deadlocks.

According to the method disclosed in Patent Document 1, however, the size of the message communication buffer is proportionate to the number of messages that are likely to be held unprocessed. When the number of messages that are likely to be held unprocessed is extremely high, the size of the message communication buffer needs to be extremely large, which is not efficient in terms of the utilization of the memory resources. In addition, when not being able to specify the number of messages that are likely to be held unprocessed, an unlimited number of regions need to be provided for the message communication buffer, which is not unrealistic.

### SUMMARY

The present invention was contrived in view of such circumstances, and an object thereof is to prevent the occurrence of deadlocks regardless of the size of a message communication buffer in a structured P2P network or without securing a large message communication buffer.

A data transfer apparatus according to one aspect of the present invention has: a routing table storage unit configured to store a routing table including an identifier, a first address and a second address of one or more other data transfer apparatuses connected to one another via a network; a first transfer unit configured to: once receiving data sent to a first address of the own apparatus (data transfer apparatus), determine another data transfer apparatus as a data transfer destination, based on a relationship between a key calculated from the data and identifiers of the one or more other data transfer apparatuses included in the routing table; and

transmit the data to a first address of the another data transfer apparatus when a magnitude relationship between the identifier of the own apparatus and the identifier of the another data transfer apparatus is in one condition, and transmit the data to a second address of the another data transfer apparatus when the magnitude relationship is in the other condition; and a second transfer unit configured to: once receiving data sent to a second address of the own apparatus, determine another data transfer apparatus as a data transfer destination, based on a relationship between a key of the data and identifiers of the one or more data transfer apparatuses included in the routing table, and transmit the data to a second address of the another data transfer apparatus.

A data transfer method according to one aspect of the present invention for causing each of a plurality of data transfer apparatuses connected to one another via a network in a data distribution system, to perform: storing a routing table including an identifier, first address and second address of one or more other data transfer apparatuses; once receiving data sent to a first address of an own apparatus: determining a data receiver or another data transfer apparatus as a data transfer destination, based on a relationship between a key calculated from the data and the identifier of the one or more data transfer apparatuses included in the routing table; transmitting the data to the data receiver when the data receiver is determined as the data transfer destination; transmitting the data to the first address of the another data transfer apparatus when the another data transfer apparatus is determined as the data transfer destination and when a magnitude relationship between an identifier of the own apparatus and the identifier of the another data transfer apparatus is in one condition; and transmitting the data to the second address of the another data transfer apparatus when one the magnitude relationship is in the other condition; once receiving data sent to a second address of the own apparatus: determining the data receiver or another data transfer apparatus as a data transfer destination, based on a relationship between a key calculated from the data and the identifier of the one or more data transfer apparatuses included in the routing table; transmitting the data to the data receiver when the data receiver is determined as the data transfer destination; and transmitting the data to the second address of another data transfer apparatus when the another data transfer apparatus is determined as the data transfer destination.

Note that the term “unit” described in the present invention does not only represent physical means but also connotates means for realizing its function by means of software. A function of a single “unit” or apparatus may be realized by two or more physical means or devices, and functions of two or more “units” or apparatuses may be realized by single physical means or device.

The present invention can prevent the occurrence of deadlocks regardless of the size of a message communication buffer in a structured P2P network or without securing a large message communication buffer.

### DESCRIPTION OF THE DRAWINGS

FIG. 1 is a diagram showing the entire configuration of a data distribution system according to an embodiment of the present invention;

FIG. 2 is a diagram showing an example of a configuration of a data transfer apparatus;

FIG. 3 is a diagram showing an example of a structure of a routing table;

FIG. 4 is a diagram showing an example of a structure of a predecessor storage unit;

FIG. 5 is a diagram showing an example of internal configurations of data transfer apparatuses and an example of a flow of data therein;

FIG. 6 is a diagram showing an example of a configuration of a ring in the data distribution system;

FIG. 7 is a diagram showing an example of a virtual configuration of the data distribution system;

FIG. 8 is a flowchart showing an example of a data transfer process performed in a first transfer unit;

FIG. 9 is a flowchart showing an example of a search process for searching for a transfer-destination data transfer apparatus;

FIG. 10 is a flowchart showing an example of a data transfer process performed in a second transfer unit;

FIG. 11 is a flowchart showing an example of a process for generating/managing a routing table;

FIG. 12 is a flowchart showing an example a routing table initializing process;

FIG. 13 is a flowchart showing an example of a successor/predecessor initializing process;

FIG. 14 is a flowchart showing an example of a routing table updating process performed in another data transfer apparatus;

FIG. 15 is a flowchart showing an example of a routing table updating process executed in another data transfer apparatus;

FIG. 16 is a diagram showing an example of an order in which the data transfer apparatuses are added to the data distribution system;

FIG. 17 is a diagram showing an example of a state of the routing table;

FIG. 18 is a diagram showing an example of a state of the predecessor storage unit;

FIG. 19 is a diagram showing an example of a state of the routing table;

FIG. 20 is a diagram showing an example of a state of the predecessor storage unit;

FIG. 21 is a diagram showing an example of a state of the predecessor storage unit;

FIG. 22 is a diagram showing an example of a state of the routing table;

FIG. 23 is a diagram showing an example of a state of the routing table;

FIG. 24 is a diagram showing an example of a state of the routing table;

FIG. 25 is a diagram showing an example of states of the routing table and of the predecessor storage unit;

FIG. 26 is a diagram showing an example of a configuration of a ring in the data distribution system; and

FIG. 27 is a diagram showing an example of internal configurations of data transfer apparatuses and an example of a flow of data therein.

### DETAILED DESCRIPTION

An embodiment of the present invention is described hereinafter with reference to the drawings.

==Configuration==

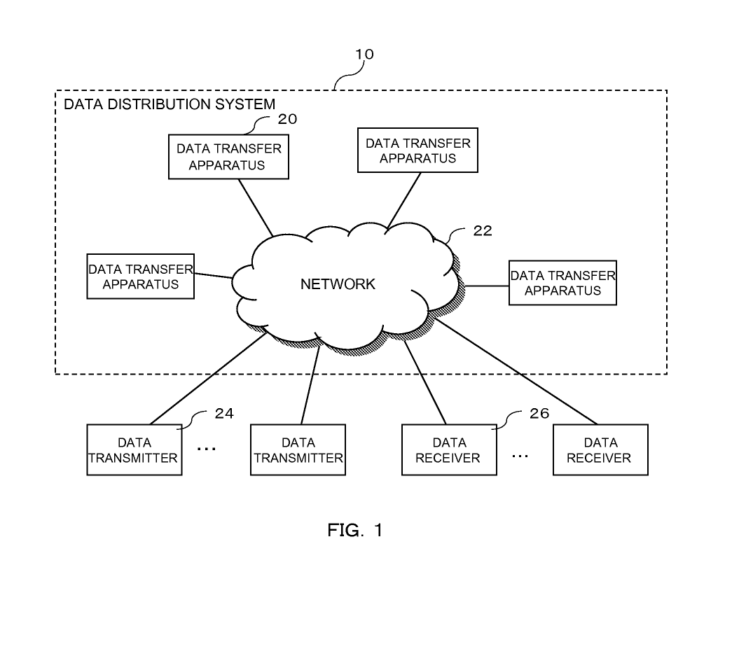

FIG. 1 is a diagram showing the entire configuration of a data distribution system according to an embodiment of the present invention. This data distribution system 10 is configured by a plurality of data transfer apparatuses 20. The data transfer apparatuses 20 are connected to each other via a network 22 such as a LAN (Local Area Network) or the Internet so as to be able to communicate with each other. In the data distribution system 10, the plurality of data transfer apparatuses 20 cooperate with each other to distribute data, which are received from a data transmitter 24, to a data receiver 26 that is in charge of processing the data.

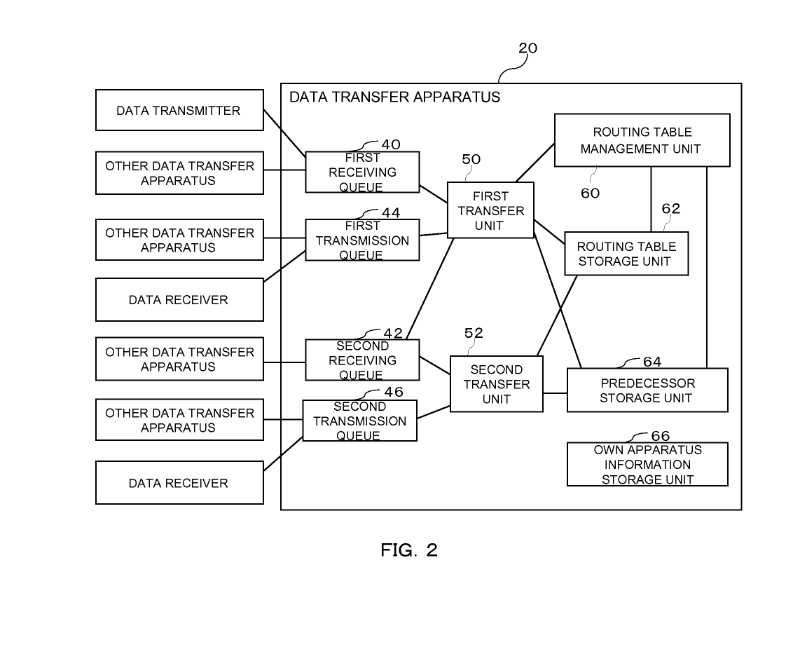

FIG. 2 is a diagram showing an example of a configuration of each data transfer apparatus 20. The data transfer apparatus 20 is configured by first and second receiving queues 40 and 42, first and second transmission queues 44 and 46, first and second transfer units 50 and 52, a routing table management unit 60, a routing table storage unit 62, a predecessor storage unit 64, and an own apparatus information storage unit 66. The data transfer apparatus 20 can be realized using one or more information processing devices. The first and second receiving queues 40 and 42, the first and second transmission queues 44 and 46, the first and second transfer unit 50 and 52, the routing table management unit 60, the routing table storage unit 62, the predecessor storage unit 64, and the own apparatus information storage unit 66 can be realized by using storage areas of memories, storage devices and the like or by causing a processor to execute programs stored in the storage areas.

The first and second receiving queues 40 and 42 each have a memory region for temporarily holding data received from the data transmitter or another data transfer apparatus. Note that the data transfer apparatus 20 has a first address and second address. Data transmitted to the first address is stored in the first receiving queue 40, and data transmitted to the second address is stored in the second receiving queue 42.

The first and second transmission queues 44 and 46 each have a memory region for temporarily holding data to be transmitted to another data transfer apparatus or the data receiver. Note that the data stored in the first and second transmission queues 44 and 46 are sequentially transmitted to a transfer destination determined by the first transfer unit 50 or the second transfer unit 52.

The first transfer unit 50 extracts the data from the first receiving queue 40 and determines another data transfer apparatus or the data receiver as a transfer destination to transfer the data to, based on a routing table stored in the routing table storage unit 62. The first transfer unit 50 then transfers the data to a transmission queue that transmits the data to the determined transfer destination. Similarly, the second transfer unit 52 extracts the data from the second receiving queue 42 and determines a transfer destination to transfer the data to, based on the routing table. The second transfer unit 52 then transfers the data to a transmission queue that transmits the data to the determined transfer destination. In the present embodiment, the first and second transfer units 50 and 52 can search the routing table to determine the transfer destinations by using hash values of the data as keys.

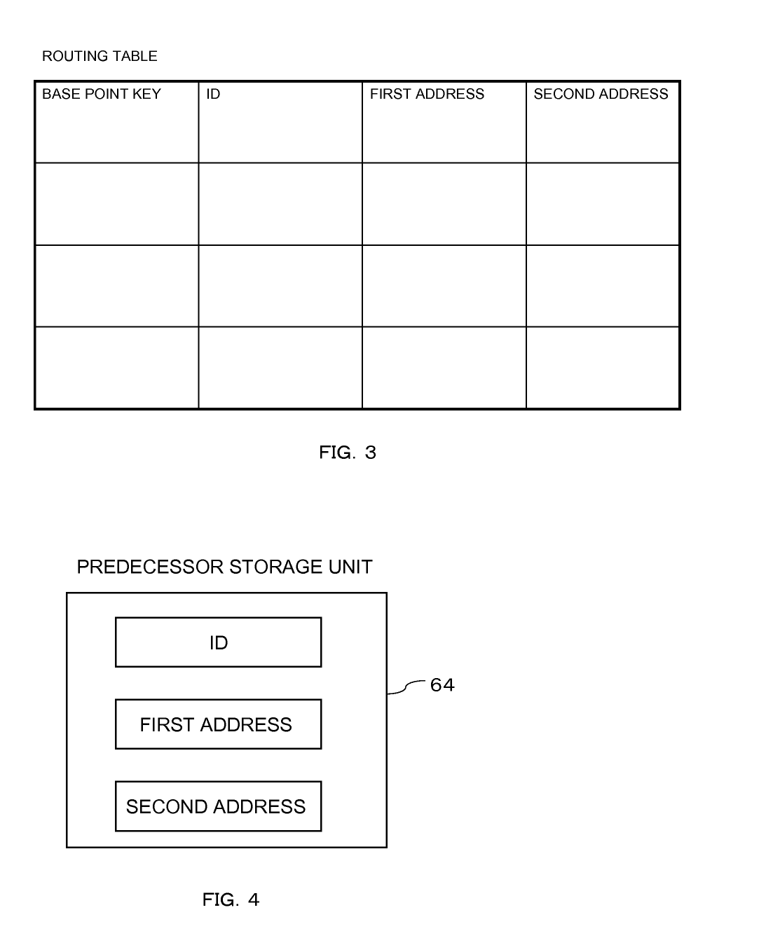

The routing table management unit 60 generates routing tables when the data transfer apparatuses 20 are added to the data distribution system 10 and stores the generated routing tables in the routing table storage unit 62. The routing table management unit 60 also updates the routing tables when another data transfer apparatus is added to the data distribution system 10 or when the configuration of the data distribution system 10 is changed. FIG. 3 shows an example of a structure of a routing table. As shown in FIG. 3, the routing table is configured by a plurality of records that include a base point key, which is a key corresponding to a base point for specifying a data transfer apparatus, an ID of a successor corresponding to the base point key, and first and second addresses of the successor. The addresses here mean information for specifying an apparatus connected to the network. When each address is configured by, for example, TCP/IP, a pair of an IP address and a port can also be used. A successor corresponding to a key k is one of the data transfer apparatuses configuring the data distribution system 10, the data transfer apparatus having, as its ID, a key that is closest to the key k (m bits) in a factor ring modulo 2^{m}.

When there exists a data transfer apparatus having the same ID as the key k, the distance between this data transfer apparatus and the key k is “0,” and, therefore, this data transfer apparatus becomes the successor of the key k.

Furthermore, the routing table management unit 60 stores an ID of a predecessor of the data transfer apparatus 20 and first and second addresses of the predecessor in the predecessor storage unit 64. Here, the predecessor means another data transfer apparatus of the data distribution system 10, which has, as its ID, a key that is farthest from the ID of the data transfer apparatus 20. FIG. 4 shows an example of the structure of the predecessor storage unit 64.

Returning to FIG. 2, the ID and the first and second addresses of the data transfer apparatus 20 (the own apparatus) are stored in the own apparatus information storage unit 66.

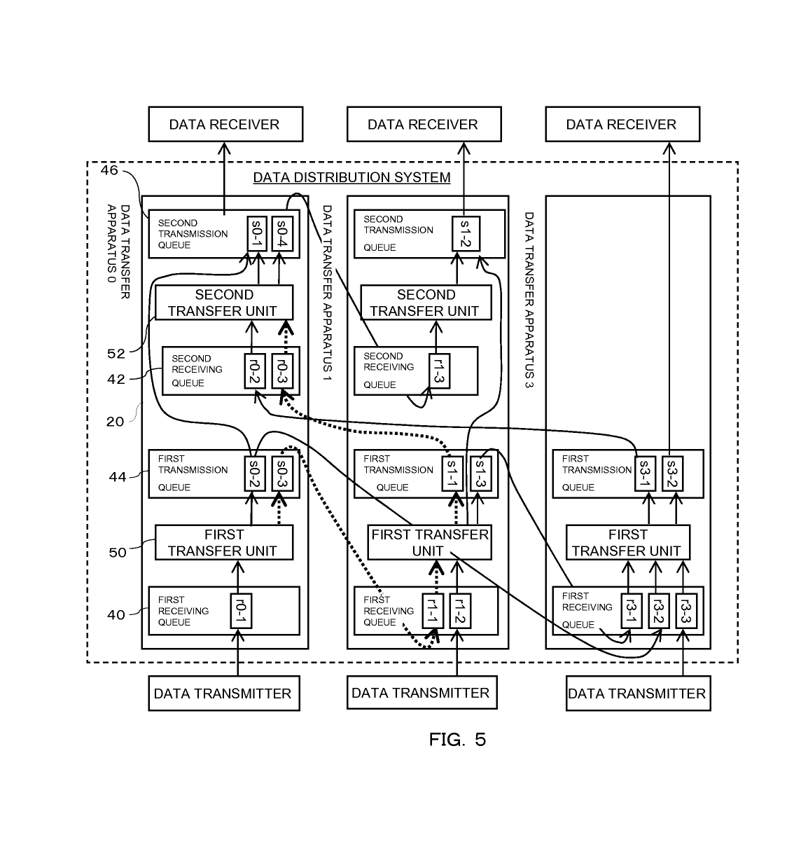

FIG. 5 is a diagram showing an example of internal configurations of three data transfer apparatuses and an example of a flow of data therein. In the present embodiment, the data transfer apparatuses 20 having IDs 0, 1, 3 are expressed as data transfer apparatuses 0, 1, 3, respectively. In the present embodiment, each of the data transfer apparatuses 20 has the first and second addresses. Data received at the first address is inserted into the first receiving queue 40, and data received at the second address is inserted into the second receiving queue 42.

The data receiver 20 that receives data through the first receiving queue 40 causes the first transfer unit 50 to determine a transfer destination to transfer the received data to, and then inserts the data into a transmission queue of the first transmission queue 44 that corresponds to the transfer destination. For instance, when the transfer destination determined by the first transfer unit of the data transfer apparatus 0 is the data transfer apparatus 1, the data is inserted into a transmission queue s0-3 of the first transmission queue 44 that corresponds to the data transfer apparatus 1.

Each data transfer apparatus 20 has its ID in the own apparatus information storage unit 66. When transferring the data received through the first receiving queue 40, and when, for example, the ID of the transfer-destination data transfer apparatus is greater than the ID of the own apparatus (when the magnitude relation ship is in one condition), the data is transmitted to the first address of the transfer destination. When, on the other hand, the ID of the transfer-destination data transfer apparatus is smaller than the ID of the own apparatus (when the magnitude relationship is in the other condition), each data transfer apparatus 20 transmits the data to the second address of the transfer destination. When transferring the data received through the second receiving queue 42 to another data transfer apparatus, each data transfer apparatus 20 transmits the data to the second address of the transfer destination.

When the determined transfer destination is the data receiver, the first transfer unit 50 or the second transfer unit 52 inserts the data into the transmission queue of the second transmission queue 46 that corresponds to the data receiver, and then transmits the data to the data receiver. However, in the data transfer apparatus having the largest ID number (the data transfer apparatus 3 in the example shown in FIG. 5), even the data to be transferred to the data receiver is inserted into the first transmission queue 44.

The data distribution system 10 according to the present embodiment described above uses the following two features of the structured P2P network. The first feature is that the data transfer apparatuses are marked with numbers and ordered into a ring, and data are transferred in this order. Depending on the routing protocol, some of the ordered data transfer apparatuses are skipped when the data are transferred. The second feature is that the data are transferred no more than one cycle.

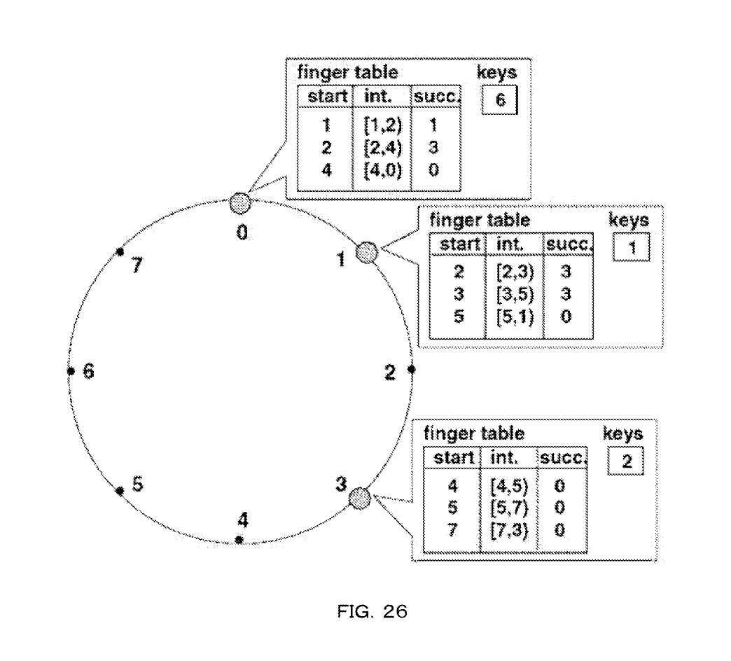

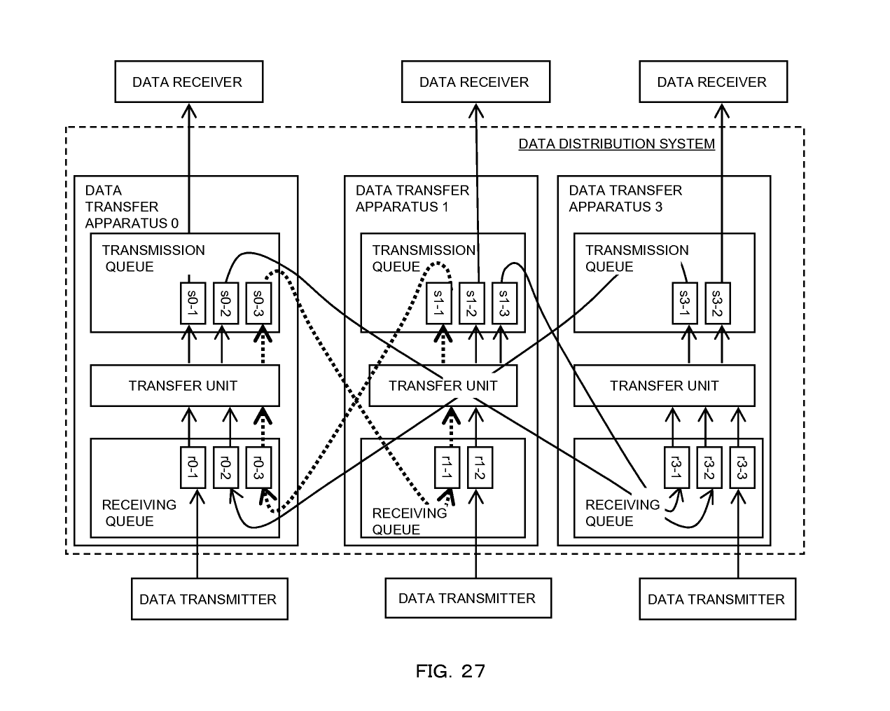

According to the first feature, the data transfer apparatuses are marked with numbers and ordered into a ring in an order of: data transfer apparatus 0, data transfer apparatus 1, data transfer apparatus 3, data transfer apparatus 0, and the like, as shown in the example in FIG. 26. The data transfer apparatus 0 transfers data to the subsequent data transfer apparatus 1 or skips the data transfer apparatus 1 to transfer the data to the data transfer apparatus 3. According to the second feature, when the data transfer apparatus 0 transmits data, received from the data transmitter, to the data transfer apparatus 1, the data transfer apparatus 1 might transfer the received data to the data transfer apparatus 3 but not to the data transfer apparatus 0. This is because the data reaches the corresponding data transfer apparatus while being transferred to the data transfer apparatus 0, the data transfer apparatus 1, and the data transfer apparatus 3 in this order.

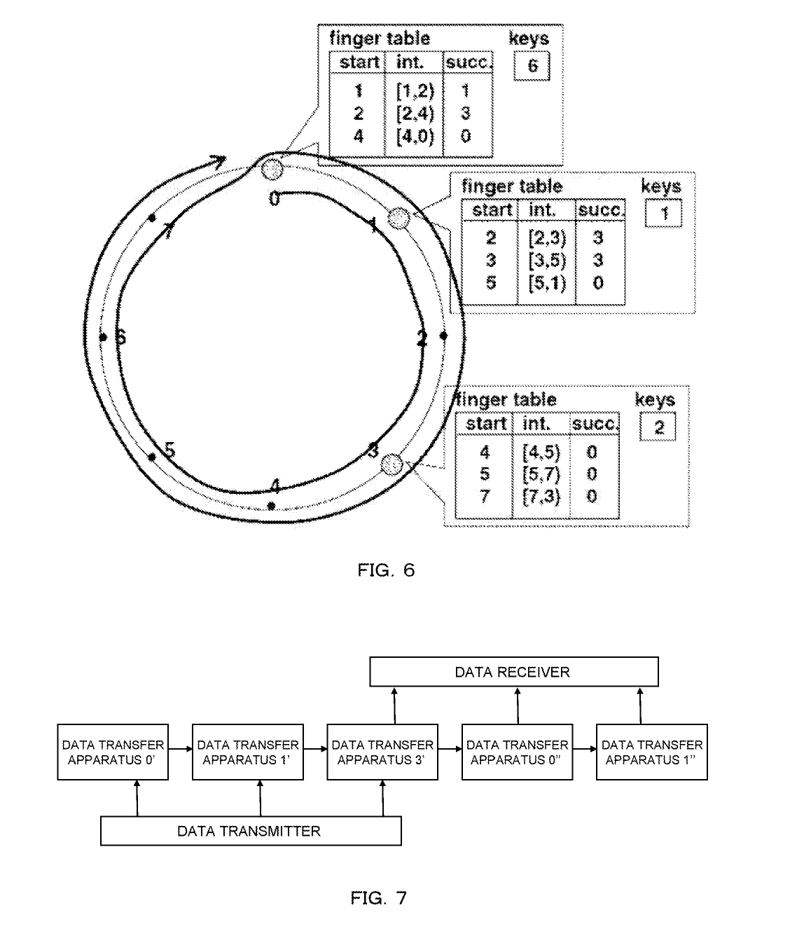

In view of these two features described above, the present embodiment prevents the occurrence of deadlocks by considering the ring shown in FIG. 26 as a double line circle shown in FIG. 6. The double line circle shown in FIG. 6 can be expressed as shown in FIG. 7. FIG. 7 shows virtual data transfer apparatuses, wherein the entities of a data transfer apparatus 0′ and a data transfer apparatus 0″ correspond to the data transfer apparatus 0, the entities of a data transfer apparatus 1′ and a data transfer apparatus 1″ correspond to the data transfer apparatus 1, and the entity of a data transfer apparatus 3′ corresponds to the data transfer apparatus 3. In FIG. 7, each arrow represents a data flow. The configuration shown in FIG. 7 can support any paths in which data are transmitted from the data transmitter to the data transfer apparatuses and reach the data receiver. For example, in FIG. 6, when data having a key 1 is transmitted from the data transmitter to the data transfer apparatus 3, the data is transferred to the data transfer apparatus 0 and the data transfer apparatus 1 in this order and then reported from the data transfer apparatus 1 to the data receiver. This data flow configures an order of: the data transfer apparatus 3′, the data transfer apparatus 0″, and the data transfer apparatus 1″ as shown in FIG. 7. In FIG. 7, the group of data transfer apparatuses 0′, 1′ and 3′ can be considered as a group of data transfer apparatuses having the first addresses, and the group of data transfer apparatuses 0″ and 1″ as a group of data transfer apparatuses having the second addresses.

==Processes==

Next are described examples of processes performed in the data distribution system 10. First, data transfer processes performed in the first and second transfer units 50 and 52 are described.

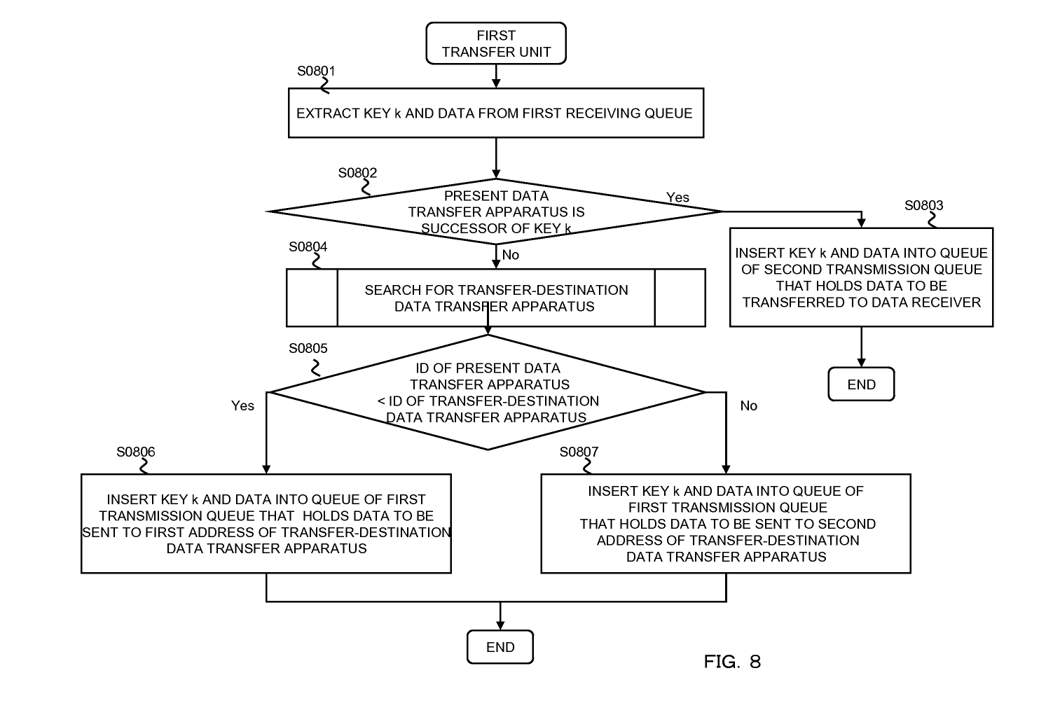

FIG. 8 is a flowchart showing an example of the data transfer process performed in the first transfer unit 50. First, the first transfer unit 50 extracts the key k and data from the first receiving queue 40 (S0801) and determines whether the present data transfer apparatus is the successor of the key k or not (S0802). Specifically, when the key k is not the ID of a predecessor stored in the predecessor storage unit 64 and the distance between the key k and this ID is shorter than the distance between this ID and the ID of the present data transfer apparatus, the present data transfer apparatus becomes the successor of the key k. It should be noted that when the key k is not stored in the first receiving queue 40, the first transfer unit 50 can obtain the key k by substituting the data extracted from the first receiving queue 40 into, for example, a hash function.

When the present data transfer apparatus is the successor of the key k (S0802: Yes), the first transfer unit 50 inserts the key k and data into a queue of the second transmission queue 46, which holds the data to be transferred to the data receiver (S0803).

When the present data transfer apparatus is not the successor of the key k (S0802: No), the first transfer unit 50 executes a search process for searching the routing table for a transfer-destination data transfer apparatus, to which the received key k and data are transferred (S0804). As a result of this search process, a record including the ID of the transfer-destination data transfer apparatus is specified. Hereinafter, the ID, first address, and second address of this specified record are referred to as the ID, first address, and second address of the transfer-destination data transfer apparatus.

Once the transfer-destination data transfer apparatus is searched, the first transfer unit 50 determines whether the ID of the transfer-destination data transfer apparatus is greater than the ID of the present data transfer apparatus or not (S0805). When the ID of the transfer-destination data transfer apparatus is greater than the ID of the present data transfer apparatus (when the magnitude relationship is in one condition) (S0805: Yes), the first transfer unit 50 inserts the key k and data into a queue of the first transmission queue 44, which holds the data to be sent to the first address of the transfer-destination data transfer apparatus (S0806). However, when the ID of the transfer-destination data transfer apparatus is smaller than the ID of the present data transfer apparatus (when the magnitude relationship is in the other condition) (S0805: No), the first transfer unit 50 inserts the key k and data into a queue of the first transmission queue 44, which holds the data to be sent to the second address of the transfer-destination data transfer apparatus (S0807).

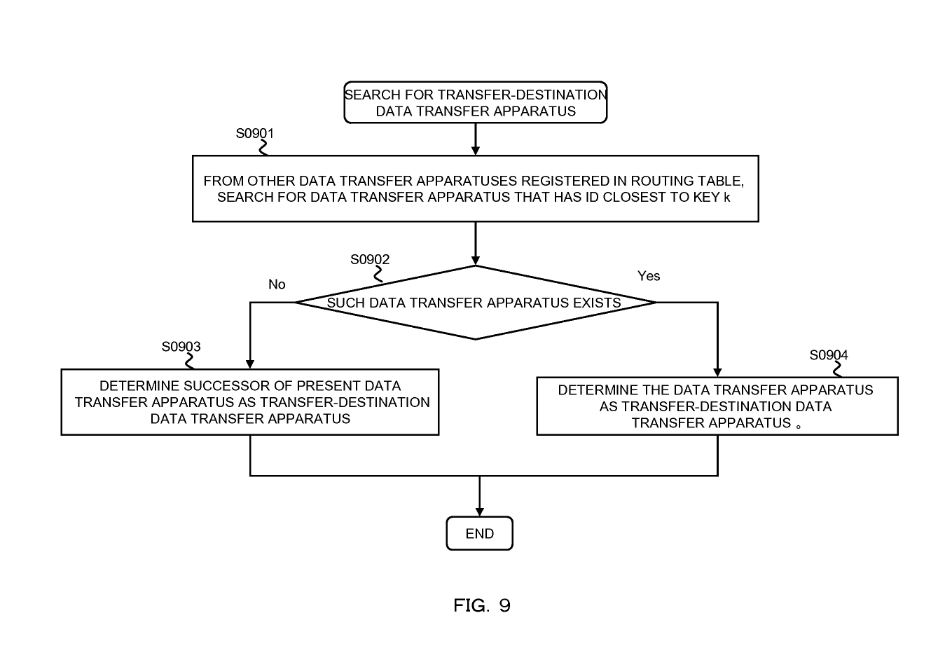

FIG. 9 is a flowchart showing an example of the search process for searching for the transfer-destination data transfer apparatus. The first transfer unit 50 searches for a data transfer apparatus that has the ID closest to the key k, out of the other data transfer apparatuses registered in the routing table (S0901). When the data transfer apparatus satisfying this condition is not registered in the routing table (S0902: No), the first transfer unit 50 determines the successor of the present data transfer apparatus as the transfer-destination data transfer apparatus (S0903). On the other hand, when the data transfer apparatus satisfying the abovementioned condition is registered in the routing table (S0902: Yes), the first transfer unit 50 determines this data transfer apparatus as the transfer-destination data transfer apparatus (S0904).

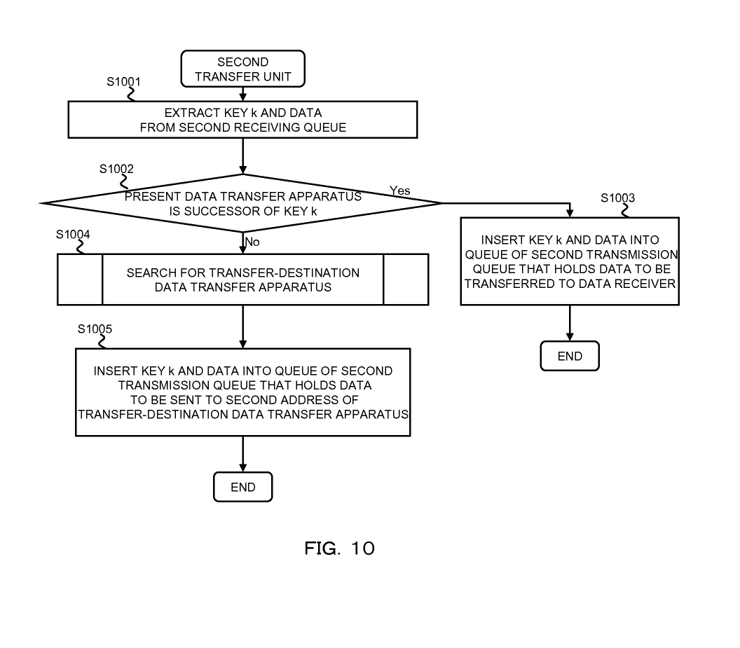

FIG. 10 is a flowchart showing an example of the data transfer process performed in the second transfer unit 52. First, the second transfer unit 52 extracts the key k and data from the second receiving queue 42 (S1001) and determines whether the present data transfer apparatus is the successor of the key k or not (S1002).

When the present data transfer apparatus is the successor of the key k (S1002: Yes), the second transfer unit 52 inserts the key k and data into a queue of the second transmission queue 46, which holds the data to be transferred to the data receiver (S1003).

When the present data transfer apparatus is not the successor of the key k (S1002: No), the second transfer unit 52 executes a search process for searching the routing table for the transfer-destination data transfer apparatus, to which the received key k and data are transferred (S1004). This search process is same as the one performed by the first transfer unit 50 (S0804).

Once the transfer-destination data transfer apparatus is searched, the second transfer unit 52 inserts the key k and data into a queue of the second transmission queue 46, which holds the data to be sent to the second address of the transfer-destination data transfer apparatus (S1005).

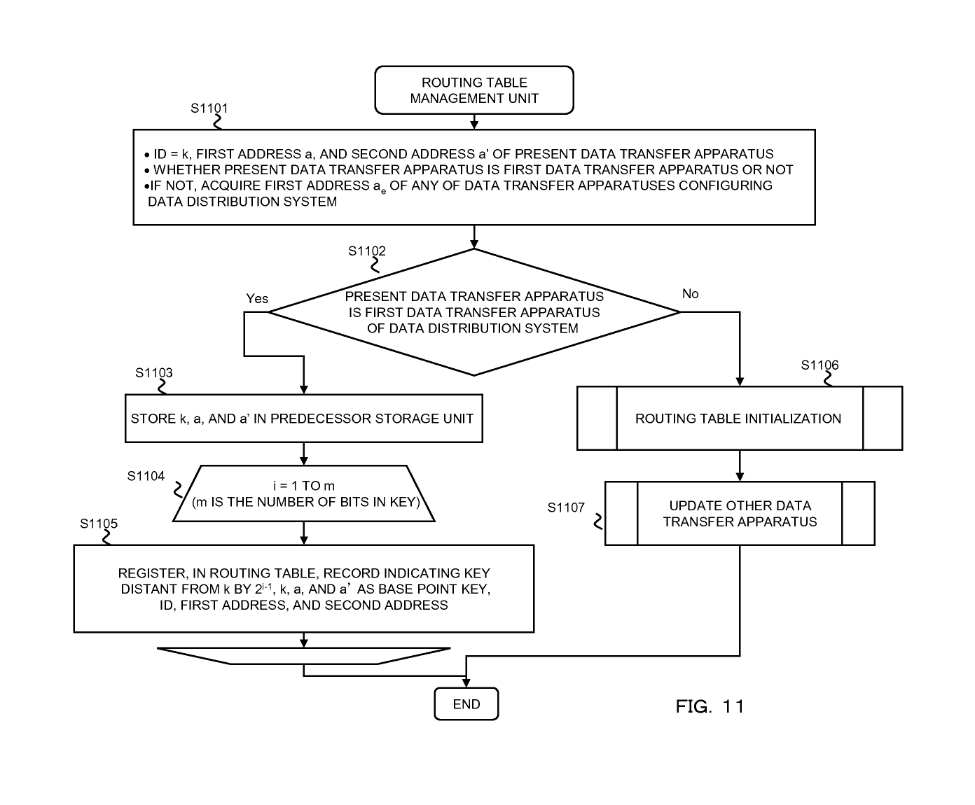

A process for generating/managing the routing table is described next. FIG. 11 is a flowchart showing an example of the process for generating/managing the routing table. First, the routing table management unit 60 acquires the ID=k, a first address a, and a second address a′ of the present data transfer apparatus from the own apparatus information storage unit 66 (S1101). The routing table management unit 60 also determines whether the present data transfer apparatus is the first data transfer apparatus of the data distribution system 10 or not, and, when the present data transfer apparatus is not the first data transfer apparatus, acquires a first address aₑ of any of the data transfer apparatuses configuring the data distribution system (S1101).

Note that whether the present data transfer apparatus is the first data transfer apparatus of the data distribution system 10 or not can be determined by, for example, storing, beforehand, information on each of the data transfer apparatuses configuring the data distribution system 10 in a predetermined storage unit provided in the data distribution system 10. This determination can also be made by, for example, transmitting a predetermined message for confirming the presence/absence of the other data transfer apparatuses, in the data distribution system 10.

When the present data transfer apparatus is the first data transfer apparatus of the data distribution system 10 (S1102: Yes), the routing table management unit 60 stores k, a, and a′ in the predecessor storage unit 64 (S1103). The routing table management unit 60 then registers, in the routing table, the records indicating a key that is distant from k by 2ⁱ⁻¹, k, a, and a′, where i=1 to m, as the base point key, ID, first address, and second address (S1104, S1105). Note that the alphabet m represents the number of bits in a key.

When the present data transfer apparatus is not the first data transfer apparatus of the data distribution system 10 (S1102: No), the routing table management unit 60 executes a routing table initializing process (S1106) and then executes an update process for updating the routing tables of the other data transfer apparatuses (S1107).

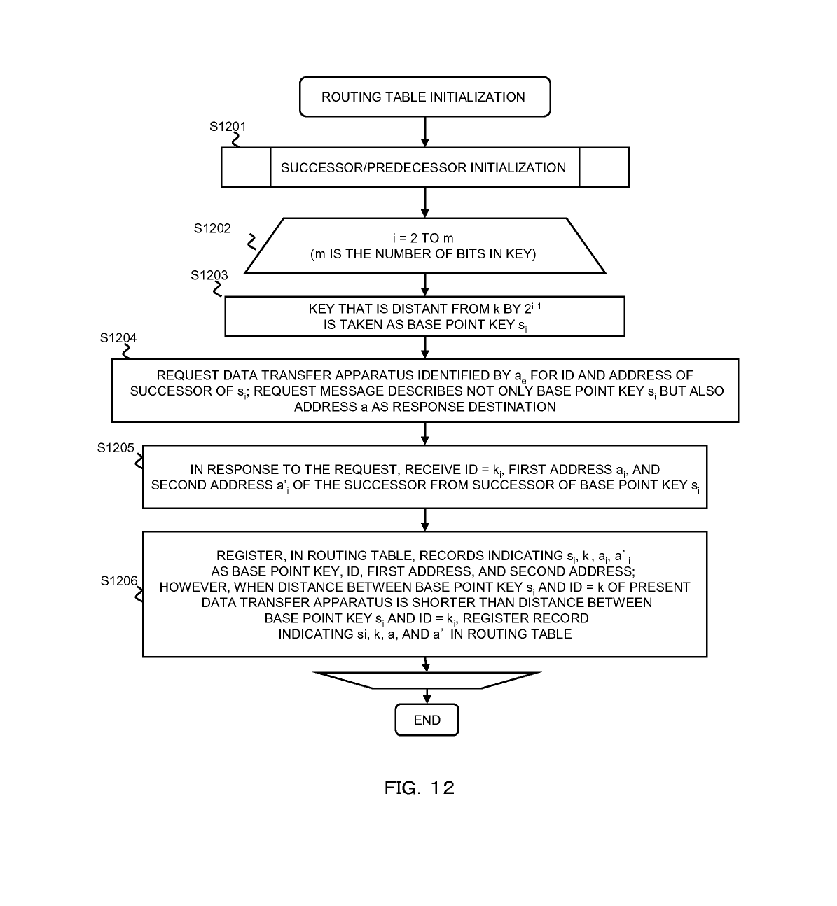

FIG. 12 is a flowchart showing an example the routing table initializing process. First, the routing table management unit 60 executes a successor/predecessor initializing process (S1201). The routing table management unit 60 then executes the following processes (S1203 to S1206) for i=2 to m (S1202).

With the key distant from the key k by 2ⁱ⁻¹ as a base point key sᵢ (S1203), the routing table management unit 60 requests the data transfer apparatus identified by aₑ for the ID and addresses of a successor of sᵢ (S1204). This request message describes not only the base point key sᵢ but also the address a indicating a response destination.

After receiving this request message, the other data transfer apparatus transfers the request message to the successor of sᵢ by performing the processes shown in FIGS. 8 to 10. The successor of sᵢ that receives this request message then transmits the ID, first address, and second address of the successor to the address a.

In response to the request, the routing table management unit 60 receives the ID=kᵢ, first address sᵢ, and second address a′ᵢ, of the successor from the successor of the base point key sᵢ (S1205). The routing table management unit 60 then registers, in the routing table, the records indicating sᵢ, kᵢ, aᵢ, and a′ᵢ as the base point key, ID, first address, and second address (S1206). However, when the distance between the base point key sᵢ and the ID=k of the present data transfer apparatus is shorter than the distance between the base point key sᵢ and the ID=kᵢ, the routing table management unit 60 registers, in the routing table, the records indicting sᵢ, k, a, and a′ as the base point key, ID, first address, and second address.

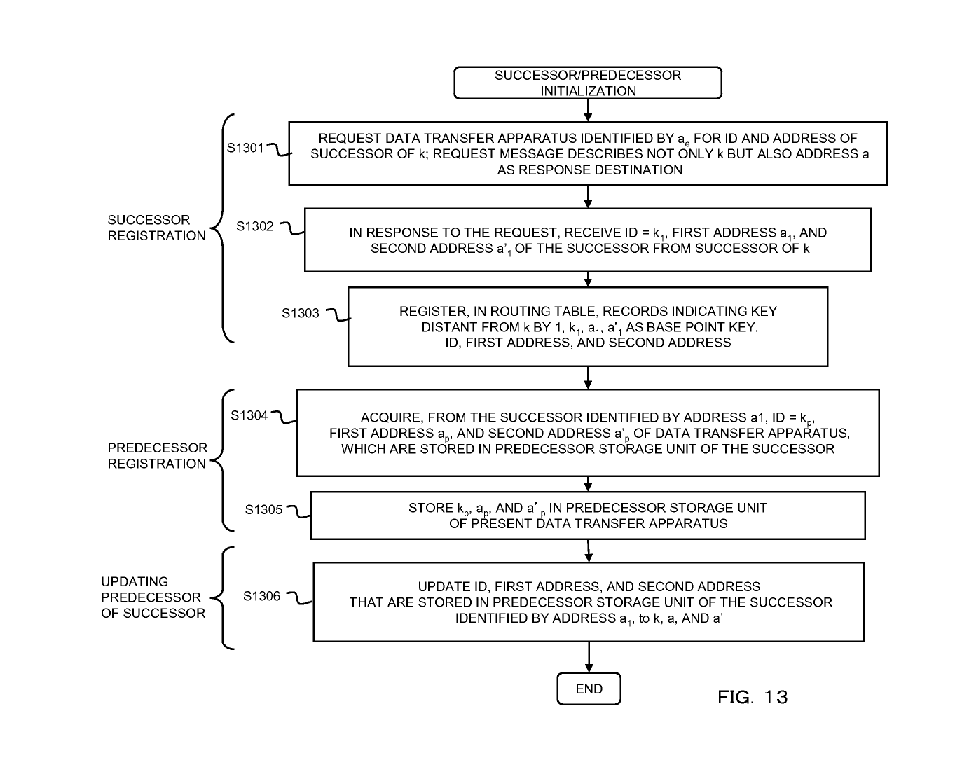

FIG. 13 is a flowchart showing an example of the successor/predecessor initializing process. The routing table management unit 60 requests the data transfer apparatus identified by aₑ for the ID and addresses of a successor of k (S1301). Note that this request message describes not only k but also the address a indicating the response destination.

After receiving this request message, the other data transfer apparatus transfers the request message to the successor of k by performing the processes shown in FIGS. 8 to 10. The successor of k that receives this request message transmits the ID, first address, and second address of the successor to the address a.

In response to the request, the routing table management unit 60 receives the ID=k₁, first address a₁, and second address a′₁ of the successor from the successor of the k (S1302). The routing table management unit 60 then registers, in the routing table, the records indicting the key k₁ that is distant from k by 1, a₁, and a′₁ as the base point key, ID, first address, and second address (S1303).

The routing table management unit 60 further acquires the ID=kₚ, first address aₚ, and second address a′ₚ of the data transfer apparatus, which are stored in the predecessor storage unit 64 of this successor, from the successor identified by the address a₁ (S1304), and then stores the acquired ID and first and second addresses in the predecessor storage unit 64 of the present data transfer apparatus (S1305).

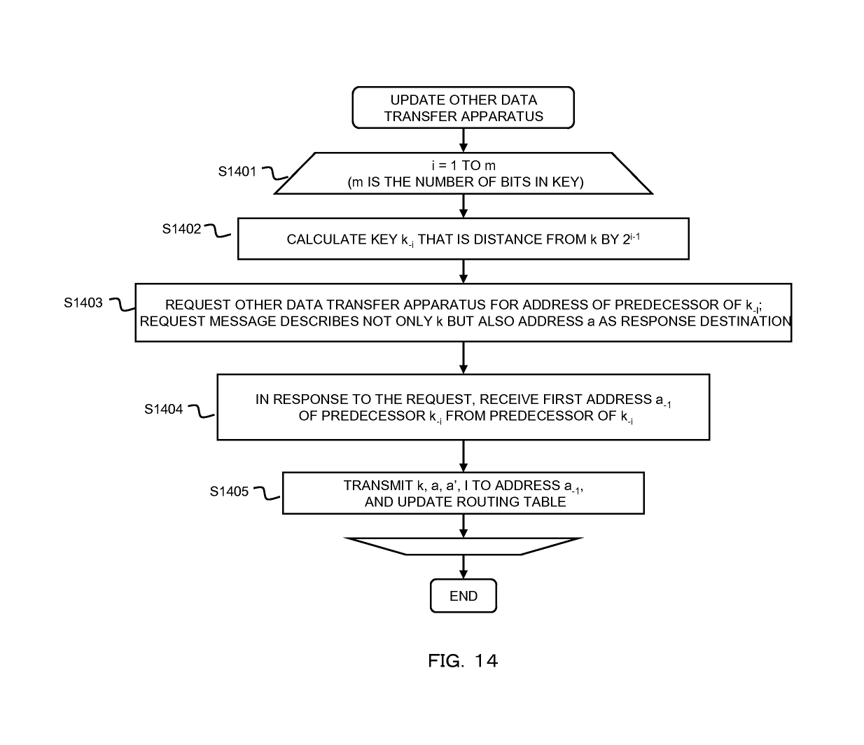

Moreover, the routing table management unit 60 updates the ID, first address, and second address that are stored in the predecessor storage unit 64 of the successor identified by the address a₁, to k, a, and a′, respectively (S1306). FIG. 14 is a flowchart showing an example of a routing table updating process performed in the other data transfer apparatus. The routing table management unit 60 executes the following processes (S1402 to S1405) for i=1 to m (S1401).

The routing table management unit 60 calculates a key k-ᵢ that is distant from k by 2ⁱ⁻¹ (S1402) and requests the other data transfer apparatus for the addresses of the predecessor of k-ᵢ (S1403). Note that the request message describes not only k but also the address a indicating the response destination.

After receiving this request message, the other data transfer apparatus transfers the request message to the predecessor of k₋ᵢ by similarly performing the processes shown in FIGS. 8 to 10. The predecessor of k₋ᵢ that receives this request message transmits the ID, first address, and second address of the predecessor to the address a. Note that, although the successor of the key is searched in the processes shown in FIGS. 8 to 10, in this case the predecessor of the key is searched. Therefore, step S0802 of the process shown in FIG. 8 is not required. Furthermore, instead of executing step S0903 of the process shown in FIG. 9, the ID, first address, and second address of the data transfer apparatus executing step S0903 are transmitted to the address of the response destination that is included in the received request message.

In response to the request, the routing table management unit 60 receives the first address a₋₁ of the predecessor of k₋ᵢ from the predecessor of k₋ᵢ (S1404). The routing table management unit 60 transmits k, a, a′ and i to the address a₋₁ and updates the routing table (S1405).

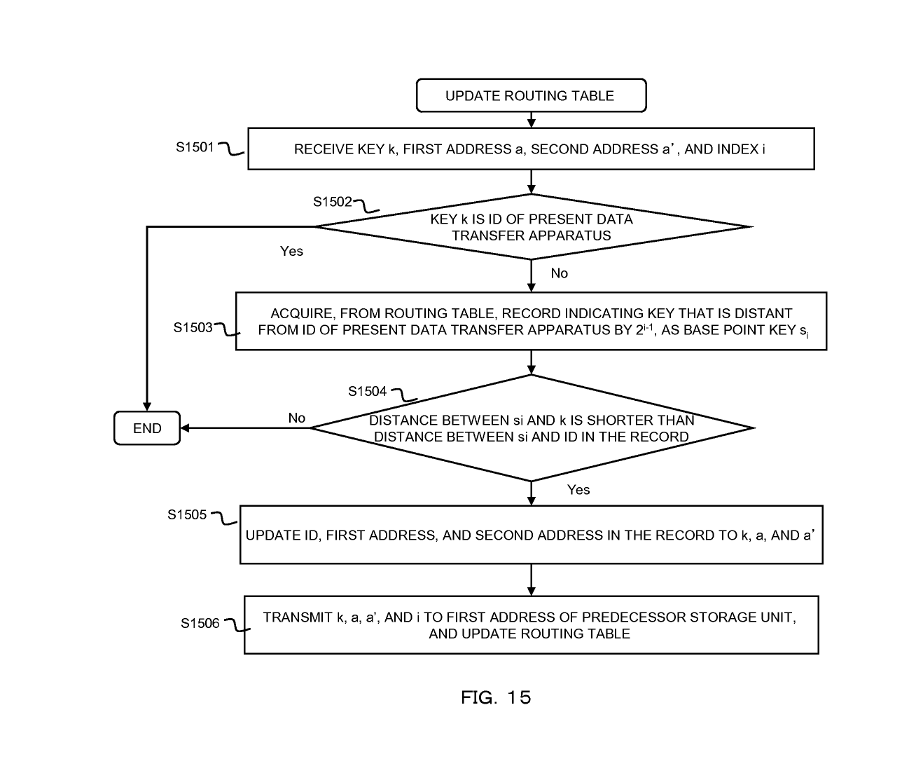

FIG. 15 is a flowchart showing an example of the routing table updating process executed by the other data transfer apparatus. The routing table management unit 60 receives the key k, the first address a, the second address a′, and the index i (S1501).

When the key k is the ID of the present data transfer apparatus (S1502: Yes), the routing table updating process is ended. When the key k is not the ID of the present data transfer apparatus (S1502: No), the routing table management unit 60 acquires, from the routing table, the record indicating, as the base point key sᵢ, a key that is distant from the ID of the present data transfer apparatus by 2ⁱ⁻¹ (S1503).

The routing table management unit 60 determines whether the distance between sᵢ and k is shorter than the distance between sᵢ and the ID in the record (S1504). When the distance between sᵢ and k is longer than the distance between sᵢ and the ID in the record (S1504: No), the routing table updating process is ended. When the distance between sᵢ and k is shorter than the distance between sᵢ and the ID in the record (S1504: Yes), the routing table management unit 60 updates the ID, first address, and second address in the record to k, a, and a′, respectively (S1505). The routing table management unit 60 then transmits k, a, a′ and i to the first address stored in the predecessor storage unit 64, and updates the routing table (S1506).

### SPECIFIC EXAMPLES

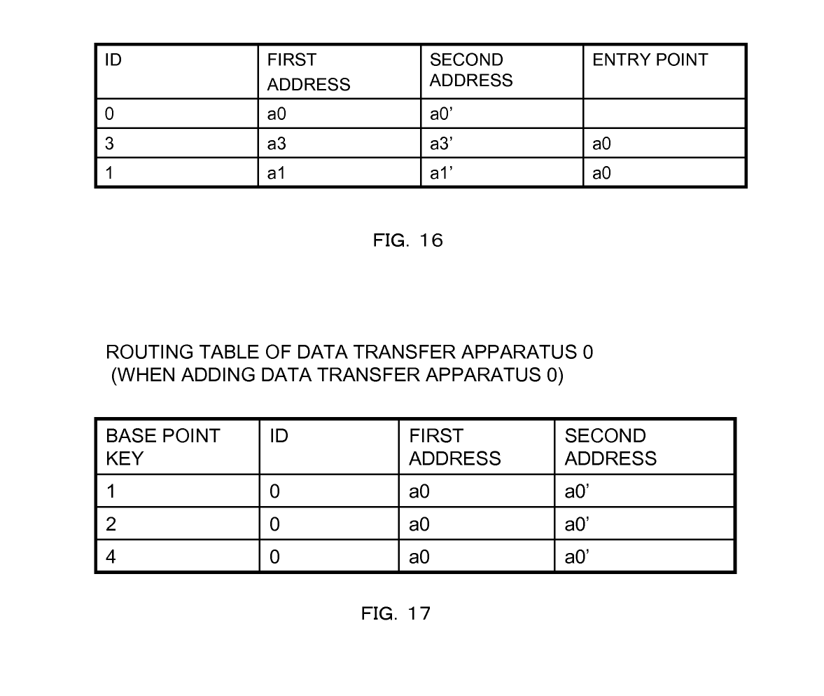

Next, operations of the data distribution system 10 are described using specific examples. In the following description, suppose that the data transfer apparatuses 20 having ID numbers 0, 3, 1 are added sequentially to the data distribution system 10, as shown in FIG. 16.

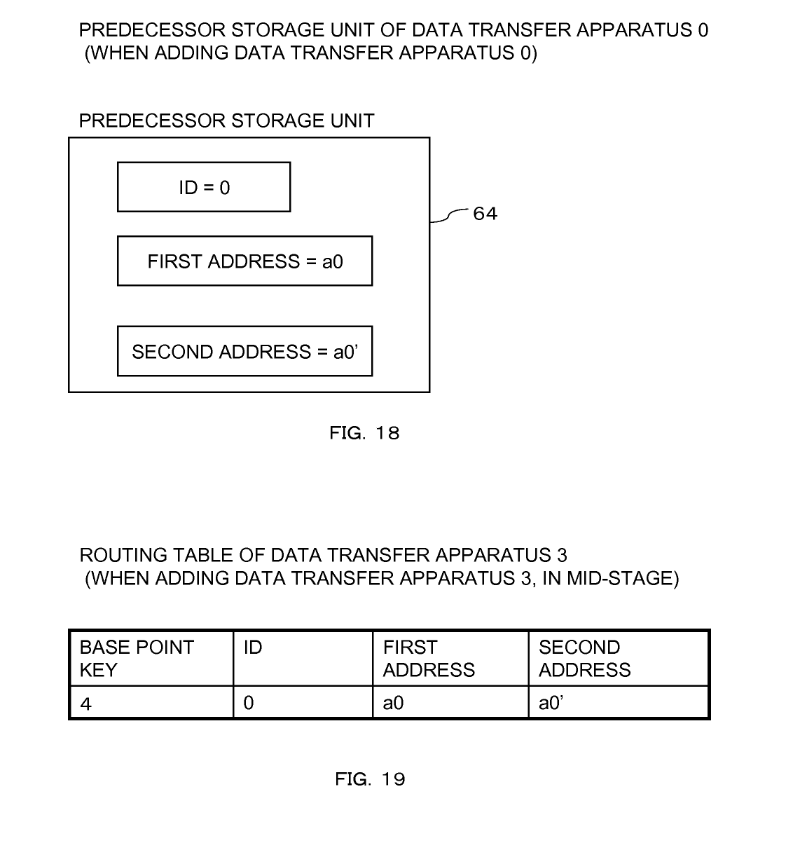

First, the data transfer apparatus 0 with ID number 0 is activated. Once the data transfer apparatus 0 is activated, the routing table management unit 60 executes the initializing process shown in FIG. 11. Because the data transfer apparatus 0 is the first data transfer apparatus of the data distribution system 10, the process proceeds to the step followed by “Yes” of step S1102. As a result of the execution of steps S1103 to S1105, the routing table storage unit 62 and the predecessor storage unit 64 of the data transfer apparatus 0 become the ones shown in FIGS. 17 and 18.

Next, the data transfer apparatus 3 with ID number 3 is activated. In the data transfer apparatus 3 or a data transfer apparatus that is activated subsequently, the process proceeds to the step followed by “No” of step S1102. In the routing table initializing process of step S1106, the successor/predecessor initializing process S1201 is executed first. In the successor/predecessor initializing process, steps S1301, S1302 are executed to acquire the ID, first address, and second address of the data transfer apparatus 0 as those of the successor of the key 3. As a result of step S1303, the routing table of the data transfer apparatus 3 is updated as shown in FIG. 19.

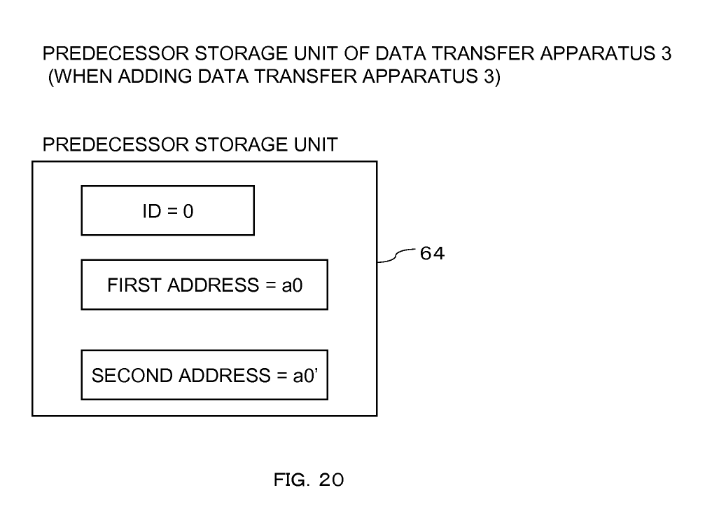

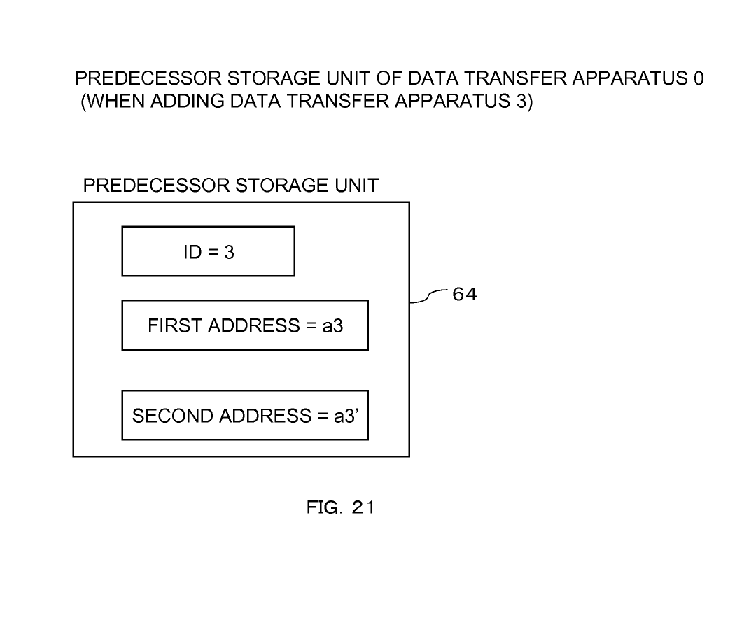

Furthermore, in step S1304 the data transfer apparatus 3 acquires, from the data transfer apparatus 0, the ID, first address, and second address of the data transfer apparatus 0 that are stored in the predecessor storage unit 64, as those of the predecessor of the data transfer apparatus 3. Then, as a result of step S1305, the predecessor storage unit 64 of the data transfer apparatus 3 becomes the one shown in FIG. 20. In step S1306 the predecessor storage unit 64 of the data transfer apparatus 0 is updated as shown in FIGS. 18 to 21. The successor/predecessor initializing process shown in FIG. 13 is completed in a manner described above.

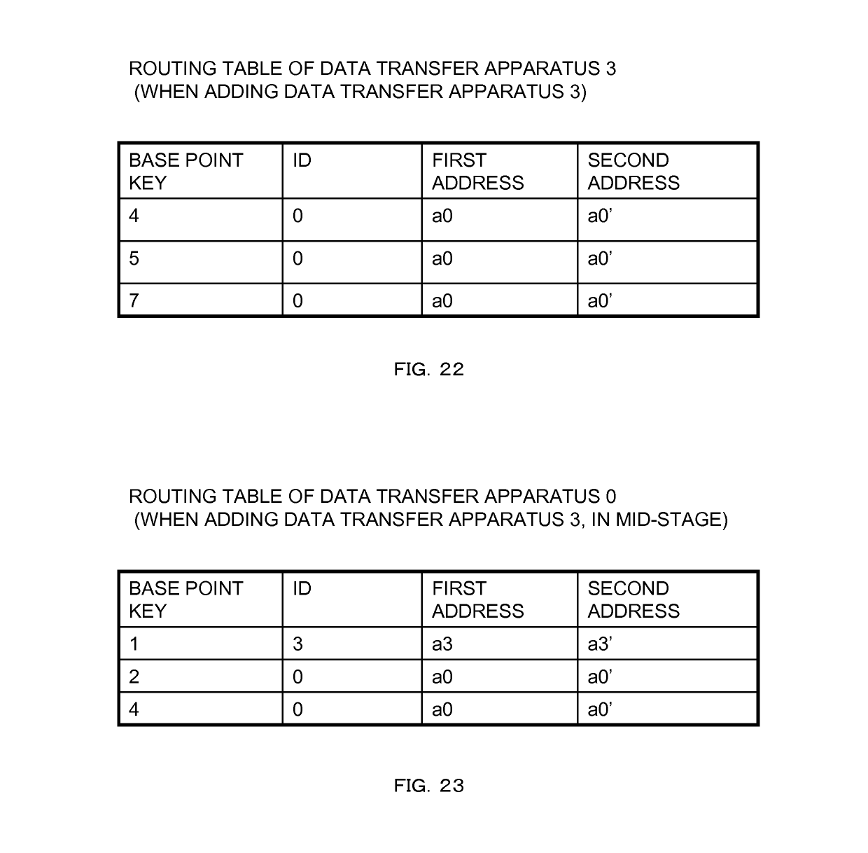

Thereafter, through the processes subsequent to step S1202 shown in FIG. 12, the routing table of the data transfer apparatus 3 is updated to the ones shown in FIGS. 19 to 22. The routing table initializing process is completed in this manner.

Next, the process S1107 for updating the routing table of the other data transfer apparatus is executed (FIG. 14). When i=1, k₋₁=3−2¹⁻¹=2 is obtained in step S1402. In steps S1403 and S1404, the ID, first address, and second address of the data transfer apparatus 0 are acquired as those of the predecessor of the key 2. Consequently, in step S1405, the ID, first address, second address, and index i=1 of the data transfer apparatus 3 are transmitted to the data transfer apparatus 0.

The data transfer apparatus 0 updates the routing table (FIG. 15). In step S1502, it is determined that the received key=3 is not the ID=0 of the data transfer apparatus 0, and, therefore, the process proceeds to step S1503. In step S1503, the record having the base point key 0+2ⁱ⁻¹=1 and the ID of the data transfer apparatus 0 is acquired from the routing table. In step S1504, because the distance between the base point key 1 and the received key 3 is shorter than the distance between the base point key 1 and the key 0 in the acquired record, the process proceeds to step S1505. In step S1505 the routing table of the data transfer apparatus 0 is changed from the one shown in FIG. 17 to the one shown in FIG. 23. In step S1506, the data transfer apparatus 0 transmits the ID, first address, second address, and index i=1 of the data transfer apparatus 3 to the data transfer apparatus 3 stored in the predecessor storage unit 64.

The data transfer apparatus 3 that receives the information from the data transfer apparatus 0 determines in step S1502 that the received key 3 is the ID of the data transfer apparatus 3, and ends the routing table updating process.

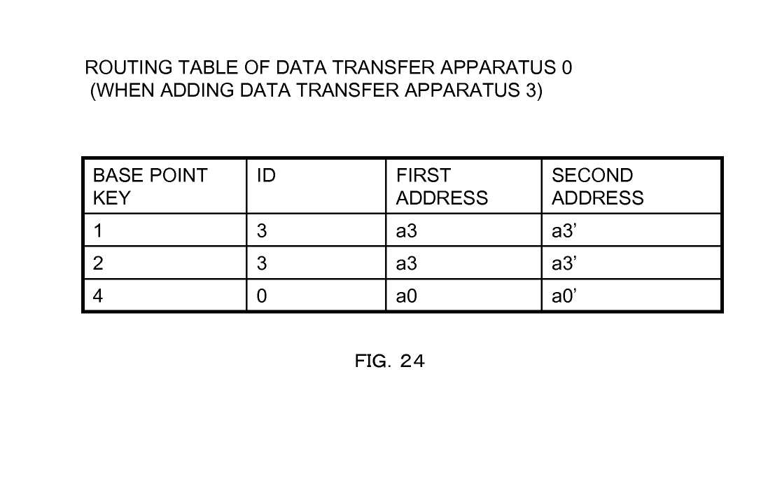

In the process for updating the routing table of the other data transfer apparatus (FIG. 14), which is performed by the data transfer apparatus 3, when i=2, the process is executed as with when i=1, and the routing table of the data transfer apparatus 0 is changed from the one shown in FIG. 23 to the one shown in FIG. 24. When i=3, the ID, first address, second address, and index i=3 of the data transfer apparatus 3 are transmitted to the data transfer apparatus 0 as a result of steps S1402 to S1405. Once receiving the information from the data transfer apparatus 3, the data transfer apparatus 0 executes the routing table updating process (FIG. 15). Because the distance between the base point key 4 and the received key 3 is longer than the distance between the base point key 4 and the ID=0 in the acquired record in step S1504 of the process shown in FIG. 15, the routing table updating process is ended.

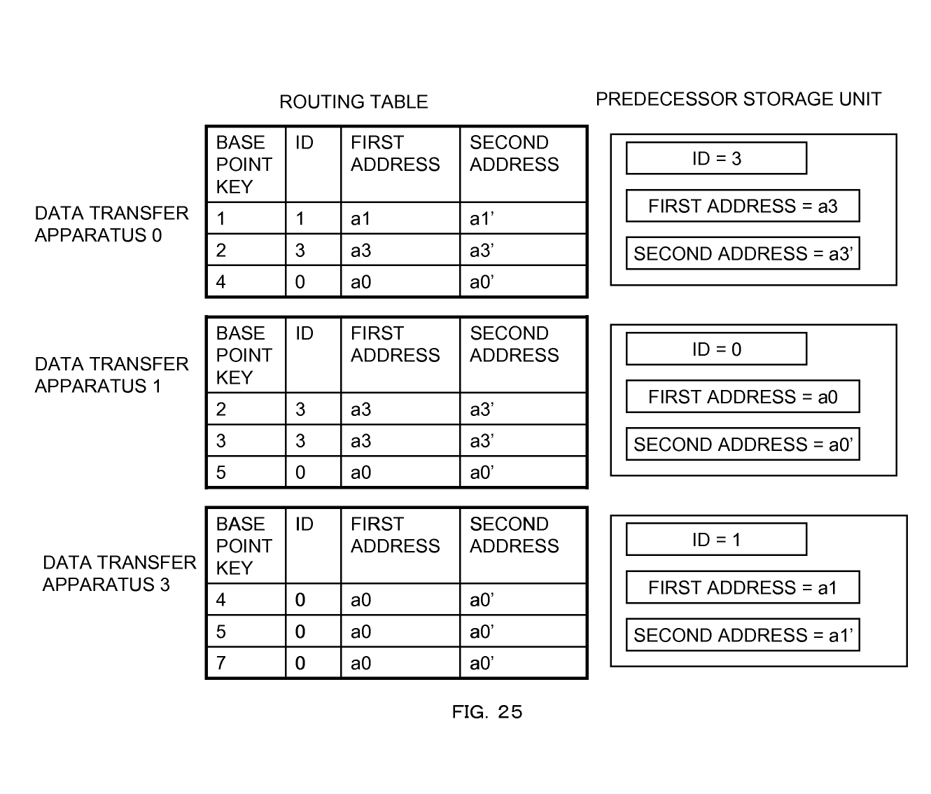

Finally, the data transfer apparatus 1 with ID number 1 is activated. Once the data transfer apparatus 1 completes the routing table initializing step S1106 and the step S1107 of updating the routing table of the other data transfer apparatus, the routing table storage unit 62 and the predecessor storage unit 64 of each data transfer apparatus are updated as shown in FIG. 25.

Next are described examples of operations that are performed in the data distribution system 10 until data transmitted from the data transmitter 24 to each data transfer apparatus 20 reaches the data receiver 26.

First of all, suppose that the data transfer apparatus 3 receives data from the data transmitter 24. The data transfer apparatus 3 inserts the received data into the first receiving queue 40. The first transfer unit 50 extracts the data from the first receiving queue 40 and calculates a hash value of the data as a key. Note that this key calculation is executed only when the data transfer apparatus receives data from the data transmitter 24. Here, suppose that the calculated key is 1.

Because the data transfer apparatus 3 is not a successor corresponding to the key=1 in step S0802 of the process shown in FIG. 8, the process proceeds to step S0804. In step S0804, the data transfer apparatus 0 is searched as the transfer-destination data transfer apparatus. This is because the data transfer apparatus 0 that has the ID closest to the key=1 is stored in the routing table of the data transfer apparatus 3. Because, in step S0805, the ID=3 of the data transfer apparatus 3 is greater than the ID=0 of the data transfer apparatus 0 in step S0805, the process proceeds to step S0807. In step S0807, key=1 and the received data are inserted into the queue of the first transmission queue 44 that holds the data to be sent to the second address of the data transfer apparatus 0 (queue s3-1 shown in FIG. 5). The data transfer apparatus 3 extracts the key and the data from the queue and transmits the extracted key and data to the second address of the data transfer apparatus 0.

The data transfer apparatus 0 inserts the key=1 and data that are received at the second address into the second receiving queue 42 (queue r0-2 shown in FIG. 5). The second transfer unit 52 of the data transfer apparatus 0 determines a transfer destination to transfer the received key=1 and data to (FIG. 10). In step S1002 of the process shown in FIG. 10, it is determined that the data transfer apparatus 0 is not a successor corresponding to the key=1, and therefore the process proceeds to step S1004. In step S1004, the data transfer apparatus 1 is searched as the transfer-destination data transfer apparatus. This is because the routing table of the data transfer apparatus 0 does not have the other data transfer apparatus that has the ID closest to the key=1 and step S0903 is executed. In step S1005, the key k and data are inserted into the queue of the second transmission queue 46 that holds the data to be sent to the second address of the data transfer apparatus 1 (queue s0-4 shown in FIG. 5). The data transfer apparatus 0 extracts the key and the data from the queue and transmits the extracted key and data to the second address of the data transfer apparatus 1.

The data transfer apparatus 1 inserts the key=1 and data that are received at the second address into the second receiving queue 42 (queue r1-3 shown in FIG. 5). The second transfer unit 52 of the data transfer apparatus 1 determines a transfer destination to transfer the received key=1 and data to (FIG. 10). In step S1002 shown in FIG. 10, it is determined that the present data transfer apparatus is not a successor corresponding to the key=1, and the process proceeds to step S1003. In step S1003, the data is inserted into the queue of the second transmission queue 46 that holds the data to be transferred to the data receiver 26 (queue s1-2 shown in FIG. 5). The data transfer apparatus 1 extracts the key and the data from the queue and transmits the extracted key and data to the data receiver 26. Through the processes described above, distribution of the data from the data transmitter 24 to the data receiver 26 via the data distribution system 10 is completed.

The above has described the present embodiment. The present embodiment can prevent the occurrence of deadlocks because each data flow is not configured into a ring. Moreover, the present embodiment can prevent the occurrence of deadlocks regardless of the size of a message communication buffer or without securing a large message communication buffer.

The present embodiment is described in order to facilitate understanding of the present invention and should not be construed as limiting the present invention. The present invention can be changed/improved without departing from the spirit thereof and includes the equivalents thereof.

According to the present embodiment, when, for example, the ID of the transfer-destination data transfer apparatus is greater than the ID of the own apparatus, it is determined that the magnitude relationship is in one condition, and when the ID of the transfer-destination data transfer apparatus is smaller than the ID of the own apparatus, it is determined that the magnitude relationship is in the other condition. However, the IDs to be prioritized can be reversed.

In addition, in the present embodiment, a ring is configured in ascending order of the IDs of the data transfer apparatuses; however, the ring may be configured in descending order of the IDs of the data transfer apparatuses.

This application claims priority based on Japanese Patent Application No. 2011-068486 filed in Japan Patent Office on Mar. 25, 2011, the entire contents of which are hereby incorporated by reference.

The invention of the present application was described above with reference to the embodiment. However, the invention of the present application is not limited thereto. Various modifications that can easily be understood by a person skilled in the art can be made to the configurations and details of the invention of the present application, within the scope of the invention of the present application.

The present embodiment can partially or entirely be described in the form of the notes described hereinafter but is not limited thereto.
(Note 1) A data transfer apparatus, comprising: a routing table storage unit configured to store a routing table including an identifier, a first address and a second address of one or more other data transfer apparatuses connected to one another via a network; a first transfer unit configured to: once receiving data sent to a first address of the own apparatus (data transfer apparatus), determine another data transfer apparatus as a data transfer destination, based on a relationship between a key calculated from the data and identifiers of the one or more other data transfer apparatuses included in the routing table; and transmit the data to a first address of the another data transfer apparatus when a magnitude relationship between the identifier of the own apparatus and the identifier of the another data transfer apparatus is in one condition, and transmit the data to a second address of the another data transfer apparatus when the magnitude relationship is in the other condition; and a second transfer unit configured to: once receiving data sent to a second address of the own apparatus, determine another data transfer apparatus as a data transfer destination, based on a relationship between a key of the data and identifiers of the one or more data transfer apparatuses included in the routing table, and transmit the data to a second address of the another data transfer apparatus.
(Note 2) The data transfer apparatus according to note 1, wherein, when the key of the data and the identifier of the own apparatus are in a predetermined relationship, the first and second transfer units are configured to determine a data receiver as the data transfer destination.
(Note 3) The data transfer apparatus according to note 2, wherein, when the own apparatus has an identifier closest to the key (m bits) of the data in a factor ring modulo 2^{m}, the first and second transfer units are configured to determine the data receiver as the data transfer destination.
(Note 4) The data transfer apparatus according to any one of notes 1 to 3, wherein, when the one or more other data transfer apparatuses included in the routing table have a data transfer apparatus having an identifier closer to the key of the data than the identifier of the own apparatus, the first and second transfer units are configured to determine a data transfer apparatus having an identifier closest to the key of the data as the data transfer destination, and when the distance between the identifier of the own apparatus and the key of the data is the closest, the first and second transfer units are configured to determine a data transfer apparatus having an identifier closest to the identifier of this data transfer apparatus as the data transfer destination.
(Note 5) The data transfer apparatus according to any one of notes 1 to 4, further comprising: a routing table management unit configured to: transmit the identifier, first address and second address of the own apparatus to another data transfer apparatus in order to update the routing table of the another data transfer apparatus, and; once the identifier, first address and second address of another data transfer apparatus are received from the another data transfer apparatus, update first and second addresses in a record identified by the identifier of the another data transfer apparatus in the routing table, to received first and second addresses.
(Note 6) The data transfer apparatus according to note 5, further comprising: a predecessor storage unit configured to store an identifier, first address and second address of a data transfer apparatus farthest from the identifier of the own apparatus, wherein the routing table management unit is configured to: transmit the identifier, first address and second address of the own apparatus to another data transfer apparatus in order to update a predecessor storage unit of the another data transfer apparatus having an identifier closest to the identifier of the own apparatus; acquire, from the another data transfer apparatus, an identifier, first address and second address stored in the predecessor storage unit of the another data transfer apparatus; and store the acquired information in the predecessor storage unit of the own apparatus.
(Note 7) The data transfer apparatus according to note 5 or 6, wherein the routing table management unit is configured to calculate a key (m bits) distant from the identifier of the own apparatus in a factor ring modulo 2^{m} by 2ⁱ⁻¹ (i=1, 2, . . . , m), and store an identifier, first address and second address of a data transfer apparatus having the identifier closest to the key in the routing table in association with the key.
(Note 8) The data transfer apparatus according to note 7, wherein, when the own apparatus is a data transfer apparatus closest to a key distant from the identifier of another data transfer apparatus by 2ⁱ⁻¹, the routing table management unit is configured to transmit the identifier, first address and second address of the own apparatus to the another data transfer apparatus in order to update the routing table of the another data transfer apparatus.
(Note 9) The data transfer apparatus according to any one of notes 1 to 8, further comprising: a first receiving queue configured to temporarily store data received at the first address of the own apparatus; a second receiving queue configured to temporarily store data received at the second address of the own apparatus; a first transmission queue having a queue for each first address of the other data transfer apparatuses; and a second transmission queue having a queue for each second address of the other data transfer apparatuses, wherein, when the data stored in the first receiving queue is transmitted to the first address of the other data transfer apparatus, the first transfer unit is configured to insert the data into a queue of the first transmission queue corresponding to the first address, and when the data stored in the first receiving queue is transmitted to the second address of the other data transfer apparatus, the first transfer unit is configured to insert the data into a queue of the second transmission queue corresponding to the second address, and wherein when the data stored in the second receiving queue is transmitted to the second address of the other data transfer apparatus, the second transfer unit is configured to insert the data into a queue of the second transmission queue corresponding to the second address.
(Note 10) A data transfer method for causing each of a plurality of data transfer apparatuses connected to one another via a network in a data distribution system, to perform: storing a routing table including an identifier, first address and second address of one or more other data transfer apparatuses; once receiving data sent to a first address of the own apparatus (data transfer apparatus): determining a data receiver or another data transfer apparatus as a data transfer destination, based on a relationship between a key calculated from the data and the identifier of the one or more data transfer apparatuses included in the routing table; transmitting the data to the data receiver when the data receiver is determined as the data transfer destination; transmitting the data to the first address of the another data transfer apparatus when the another data transfer apparatus is determined as the data transfer destination and when a magnitude relationship between an identifier of the own apparatus and the identifier of the another data transfer apparatus is in one condition; and transmitting the data to the second address of the another data transfer apparatus when one the magnitude relationship is in the other condition; once receiving data sent to a second address of the own apparatus: determining the data receiver or another data transfer apparatus as a data transfer destination, based on a relationship between a key calculated from the data and the identifier of the one or more data transfer apparatuses included in the routing table; transmitting the data to the data receiver when the data receiver is determined as the data transfer destination; and transmitting the data to the second address of another data transfer apparatus when the another data transfer apparatus is determined as the data transfer destination.
10 Data distribution system
20 Data transfer apparatus
22 Network
24 Data transmitter
26 Data receiver
40 First receiving queue
42 Second receiving queue
44 First transmission queue
46 Second transmission queue
50 First transfer unit
52 Second transfer unit
60 Routing table management unit
62 Routing table storage unit
64 Predecessor storage unit
66 Own apparatus information storage unit

1. A data transfer apparatus, comprising:
a routing table storage unit configured to store a routing table including an identifier, a first address and a second address of one or more other data transfer apparatuses connected to one another via a network;
a first transfer unit configured to:
once receiving data sent to a first address of the own apparatus (data transfer apparatus), determine another data transfer apparatus as a data transfer destination, based on a relationship between a key calculated from the data and identifiers of the one or more other data transfer apparatuses included in the routing table; and
transmit the data to a first address of the another data transfer apparatus when a magnitude relationship between the identifier of the own apparatus and the identifier of the another data transfer apparatus is in one condition, and transmit the data to a second address of the another data transfer apparatus when the magnitude relationship is in the other condition; and
a second transfer unit configured to:
once receiving data sent to a second address of the own apparatus, determine another data transfer apparatus as a data transfer destination, based on a relationship between a key of the data and identifiers of the one or more data transfer apparatuses included in the routing table, and transmit the data to a second address of the another data transfer apparatus.

2. The data transfer apparatus according to claim 1, wherein, when the key of the data and the identifier of the own apparatus are in a predetermined relationship, the first and second transfer units are configured to determine a data receiver as the data transfer destination.

3. The data transfer apparatus according to claim 2, wherein, when the own apparatus has an identifier closest to the key (m bits) of the data in a factor ring modulo 2^{m}, the first and second transfer units are configured to determine the data receiver as the data transfer destination.

4. The data transfer apparatus according to claim 1, wherein,
when the one or more other data transfer apparatuses included in the routing table have a data transfer apparatus having an identifier closer to the key of the data than the identifier of the own apparatus, the first and second transfer units are configured to determine a data transfer apparatus having an identifier closest to the key of the data as the data transfer destination, and
when the distance between the identifier of the own apparatus and the key of the data is the closest, the first and second transfer units are configured to determine a data transfer apparatus having an identifier closest to the identifier of this data transfer apparatus as the data transfer destination.

5. The data transfer apparatus according to claim 1, further comprising:
a routing table management unit configured to:
transmit the identifier, first address and second address of the own apparatus to another data transfer apparatus in order to update the routing table of the another data transfer apparatus, and;
once the identifier, first address and second address of another data transfer apparatus are received from the another data transfer apparatus, update first and second addresses in a record identified by the identifier of the another data transfer apparatus in the routing table, to received first and second addresses.

6. The data transfer apparatus according to claim 5, further comprising:
a predecessor storage unit configured to store an identifier, first address and second address of a data transfer apparatus farthest from the identifier of the own apparatus,
wherein the routing table management unit is configured to:
transmit the identifier, first address and second address of the own apparatus to another data transfer apparatus in order to update a predecessor storage unit of the another data transfer apparatus having an identifier closest to the identifier of the own apparatus;
acquire, from the another data transfer apparatus, an identifier, first address and second address stored in the predecessor storage unit of the another data transfer apparatus; and
store the acquired information in the predecessor storage unit of the own apparatus.

7. The data transfer apparatus according to claim 5, wherein the routing table management unit is configured to calculate a key (m bits) distant from the identifier of the own apparatus in a factor ring modulo 2^{m} by 2ⁱ⁻¹ (i =1, 2, . . . , m), and store an identifier, first address and second address of a data transfer apparatus having the identifier closest to the key in the routing table in association with the key.

8. The data transfer apparatus according to claim 7, wherein, when the own apparatus is a data transfer apparatus closest to a key distant from the identifier of another data transfer apparatus by 2ⁱ⁻¹, the routing table management unit is configured to transmit the identifier, first address and second address of the own apparatus to the another data transfer apparatus in order to update the routing table of the another data transfer apparatus.

9. The data transfer apparatus according to claim 1, further comprising:
a first receiving queue configured to temporarily store data received at the first address of the own apparatus;
a second receiving queue configured to temporarily store data received at the second address of the own apparatus;
a first transmission queue having a queue for each first address of the other data transfer apparatuses; and
a second transmission queue having a queue for each second address of the other data transfer apparatuses,
wherein, when the data stored in the first receiving queue is transmitted to the first address of the other data transfer apparatus, the first transfer unit is configured to insert the data into a queue of the first transmission queue corresponding to the first address, and when the data stored in the first receiving queue is transmitted to the second address of the other data transfer apparatus, the first transfer unit is configured to insert the data into a queue of the second transmission queue corresponding to the second address, and wherein
when the data stored in the second receiving queue is transmitted to the second address of the other data transfer apparatus, the second transfer unit is configured to insert the data into a queue of the second transmission queue corresponding to the second address.

10. A data transfer method for causing each of a plurality of data transfer apparatuses connected to one another via a network in a data distribution system, to perform:
storing a routing table including an identifier, first address and second address of one or more other data transfer apparatuses;
once receiving data sent to a first address of the own apparatus (data transfer apparatus):
determining a data receiver or another data transfer apparatus as a data transfer destination, based on a relationship between a key calculated from the data and the identifier of the one or more data transfer apparatuses included in the routing table;
transmitting the data to the data receiver when the data receiver is determined as the data transfer destination;
transmitting the data to the first address of the another data transfer apparatus when the another data transfer apparatus is determined as the data transfer destination and when a magnitude relationship between an identifier of the own apparatus and the identifier of the another data transfer apparatus is in one condition; and
transmitting the data to the second address of the another data transfer apparatus when one the magnitude relationship is in the other condition;
once receiving data sent to a second address of the own apparatus:
determining the data receiver or another data transfer apparatus as a data transfer destination, based on a relationship between a key calculated from the data and the identifier of the one or more data transfer apparatuses included in the routing table;
transmitting the data to the data receiver when the data receiver is determined as the data transfer destination; and
transmitting the data to the second address of another data transfer apparatus when the another data transfer apparatus is determined as the data transfer destination.
